(19) United States
(12) Patent Application Publication
(10) Pub. No.: US 2004/0074101 A1
(43) Pub. Date: Apr. 22, 2004

(54) Rafer & stud spacer

(76) Inventor: Fred Delano Dillard, Martinsburg, WV (US)

Correspondence Address: Fred D. Dillard, 1251 Ropp Drive, Martinsburg, WV, 25401, US

(21) Appl. No.: 10/274,236

(22) Filed: Oct. 21, 2002

(51) Int. Cl. G01D 21/00

(52) U.S. Cl. 33/613

(57) ABSTRACT

My invention the “Rafter and Stud Spacer” pertains to the field of carpentry. This invention is a completely new idea replacing the traditional way of marking and spacing studs and rafters. It is a simple tool that is adjustable to “on center” measurements selected by the carpenter in the placement of studs and rafters. This eliminates the need to mark each stud and rafter placement by hand. This spacer has slide out extensions located on top when being used as a rafter spacer. This enables the spacer when placed atop the rafters to slide along while being nailed into place.

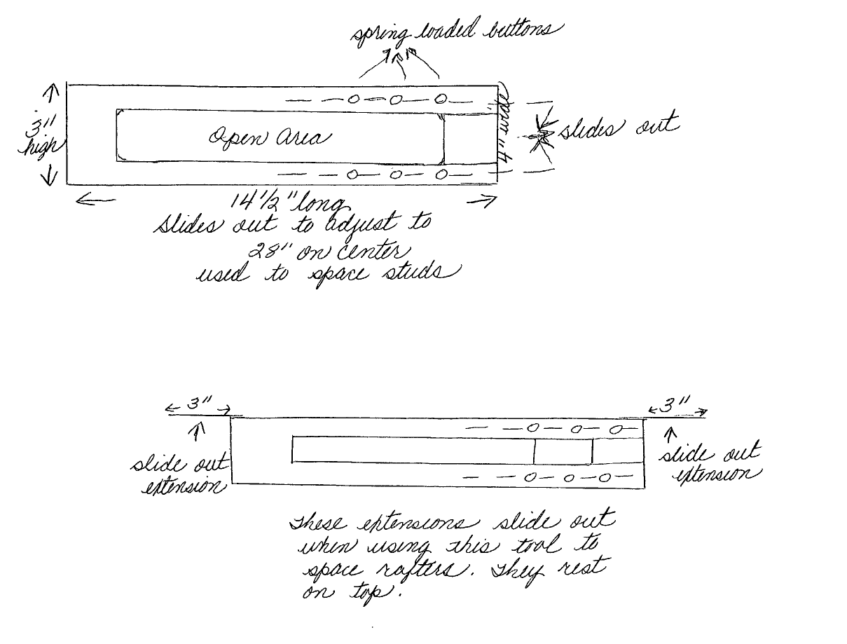

### DESCRIPTION

My “Rafter & Stud Spacer” is a very simple, easy to use timesaving carpenter's tool. Constructed of aluminum measuring 3″ in height and 3″ in width and is adjustable to 24″ on center. It is open in the center much like that of a level making it easy to pick up.

For spacing studs simply slide out to the desired on center measurement. Place spacer on the plate and place the stud against it and nail. Pick the spacer up and place it on the other side of the nailed stud and continue the process. To space rafters adjust to the desired on center measurement. Slide out the extensions located on top of the spacer. This will enable the spacer to hang freely from the rafters. This is a lightweight durable tool that definitely a time saver.

1. What I claim as my invention is a carpenter's tool which I call a “Rafter & Stud Spacer”. Back in 1976 a young man in my thirties I bagan to construct an addition to my house. As I began to place the studs I came up with the idea to cut a piece of lumber 14½″ long on which I placed a makeshift handle on top. This would serve as a spacer making it much quicker than marking the plate with a tape measure every 16″. Now some twenty years later I began to construct a garage and my old idea came back to me. Only this time I revised my earlier idea so that it could also be used to space rafters. Such a simple tool but how easy and timesaving it is. Next idea, patent it!!
